(19) United States
(12) Patent Application Publication
(10) Pub. No.: US 2026/0056116 A1
(43) Pub. Date: Feb. 26, 2026

(54) SINGLE-USE PROCESS MONITORING DEVICE AND METHODS OF USE OF SAME

(71) Applicant: Custom Sensors & Technology, Fenton, MO (US)

(72) Inventor: Thomas Mark Kornblum, Pevely, MO (US)

(21) Appl. No.: 18/809,880

(22) Filed: Aug. 20, 2024

(51) Int. Cl. G01N 21/05

(52) U.S. Cl. CPC G01N 21/05; G01N 2021/052

(57) ABSTRACT

A single use flow cell for use in-line monitoring includes a one-piece central body that is integrally formed with an optical housing, and with an optical retainer. The central body includes an inlet, an outlet, and a central bore extending therethrough from the inlet to the outlet. The optical housing includes a first end, a second end, and a interface bore that extending from the first end of the housing to the second end of the housing. The optical retainer is slidably coupled in one of an interference fit and a snap-fit within the central body such that at least a portion of the optical retainer is securely coupled within at least one opening formed within the optical housing.

### FIELD OF THE INVENTION

The present disclosure relates generally to fluid monitoring devices and, more particularly, to single-use process monitoring devices that may be used to monitor properties of a flowing fluid.

### BACKGROUND

Within at least some known process applications, during the development and manufacturing of a product, it may be necessary to monitor, in real-time or in near real-time, properties of fluids used in the process. For example, such monitoring is of particular importance in biopharmaceutical process applications. Optical absorption analyzers are commonly used to monitor fluid flowing or circulating in the process stream through a flow cell. At least some of such analyzers, transmit a beam of light energy through the fluid. Process variables of the fluid, such as turbidity or chemical concentrations, may be determined by comparing the transmitted beam of light to a reference light source.

Although monitoring the various fluid variables is essential in optimizing at least some known processes, it is more critical in most processes that the process environment remain uncontaminated when monitoring the fluid properties. One known method of reducing the likelihood of contamination is through using single or limited use components. For example, at least some known process applications use single use flow cells to enable various properties of the process fluid to be measured. More specifically, at least some known flow cells enable a fluid sample to flow through the flow cell wherein light of a pre-defined wavelength can be projected into the flow cell, and through the sample. Light discharged from the flow cell can be continuously monitored and analyzed as the fluid flows through the flow cell.

Although, flow cells have proven a reliable means for performing process measurements, the benefits of flow cells may be offset by their inherent design. For example, known flow cells are typically designed for use with a specific type of analysis, and as such may be constructed with a flow path that is specifically defined between a pair of opposed optical windows that are definitively spaced and sized to enable a specific process measurement to be obtained from the fluid flowing therebetween. Accordingly, to monitor a different process variable, a different flow cell may need to be installed. Additionally, at least some known manufacturing processes produce products in batches that require repeated cleaning, sterilization, and/or replacement of components, including flow cells. However, to ensure that reactants or process products remain uncontaminated even during the cleaning or replacement of components, at least some known process applications require adherence to strict restrictions that may make the removal, cleaning, and/or replacement of such components a time-consuming, labor-intensive, and/or costly process.

Accordingly, it would be desirable to provide a process monitoring device that maintains minimal microbial contamination while being universally adaptable to numerous process applications and that is reliable, provides accurate and repeatable results, and that is relatively inexpensive.

### BRIEF SUMMARY

In one aspect, a single use flow cell for use in-line monitoring is provided. The flow cell includes a one-piece central body that is integrally formed with an optical housing, and with an optical retainer. The central body includes an inlet, an outlet, and a central bore extending therethrough from the inlet to the outlet. The optical housing includes a first end, a second end, and a interface bore that extending from the first end of the housing to the second end of the housing. The optical retainer is slidably coupled in one of an interference fit and a snap fit within the central body such that at least a portion of the optical retainer is securely coupled within at least one opening formed within the optical housing.

In another aspect, a single use flow cell for use in monitoring a process fluid flowing therethrough is provided. The single use flow cell includes a hollow central body, a hollow optical housing that is formed integrally with the central body, and an optical retainer. The optical housing includes at least a pair of openings that are formed diametrically apart from each other. The optical retainer is slidably coupled within the optical housing such that the optical retainer is retained in one of an interference fit and a snap-fit configuration with the optical housing.

In a further aspect, an in-line process monitor is provided. The process monitor includes a one-piece central body that is integrally formed with an optical housing, and also includes an optical retainer. The central body defines a fluid flow path that extends through the central body. The optical housing includes an interface bore that extends therethrough. The optical retainer is slidably coupled within the interface bore in one of an interference fit and a snap fit. At least a portion of the optical retainer is received within a portion of the optical housing such that an intersection of the central body and the optical housing defines a monitoring chamber that is bordered at least partially by at least two windows that are oriented to enable light energy to be transmitted through the optical housing and through fluid flowing through the fluid flow path.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a perspective view of an exemplary process monitor device that may be used to monitor a process variable in real-time that facilitates maintaining an environment with minimal microbial contamination.

FIG. 2 is a partial cut-away perspective view of the process monitor device shown in FIG. 1 and taken along line 2-2, and with the optical interface assembly removed.

FIG. 3 a partially exploded perspective view of the process monitor device shown in FIG. 1.

FIG. 4 is a partial cut-away view of the process monitor device shown in FIG. 3 including the optical interface assembly.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Furthermore, as used herein, the term “real-time” refers to at least one of: the time of occurrence of the associated events, the time of measurement and collection of predetermined process data, the time for a computer device (e.g., a processor) to process the data, and/or the time of a system response to the events and the environment. In the embodiments described herein, these activities and events may be considered to occur substantially instantaneously.

In addition, as used herein, the terms “single use” or “single time use” and/or “limited use” or “limited time use” are terms of art that one of ordinary skill in the art should understand. Generally, components designed for single use, are usually complex items intended for a single use, as opposed to simple disposables. Moreover, as compared to traditional components used in biopharmaceutical manufacturing, for example, single-use components offer significant cost savings. While the initial investment in single-use components may be higher, the overall costs associated with cleaning, maintenance and validation of reusable systems, for example, are comparatively less expensive. Furthermore, with traditional components, extensive cleaning procedures, including disassembly, cleaning, rinsing and sterilization, are necessary between manufacturing runs or batches. These processes require resources, time and energy, all of which increase operating costs. Additionally, the validation of reusable systems involves regulated and mandated thorough testing and documentation to ensure compliance with regulatory standards, all of which also increases the overall expense. In contrast, single-use components, such as the process monitor described herein, do not require cleaning, sterilization and/or validation by the user. The disposable nature of the components means the single use flow cell described herein can be discarded after use, avoiding the costs associated with cleaning and sterilization procedures. Eliminating such recurring expenses can lead to long-term cost savings.

The present embodiments may relate to, inter alia, a process monitor device that is easily adaptable and/or that is easily integrated in-line to most fluid process applications. In one exemplary embodiment, the monitor device is a flow cell that is fabricated with a murphy-proofed design that enables a fluid process variable to be monitored in real-time in a manner that facilitates maintaining minimal microbial contamination, while still providing an accurate, repeatable, and reliable data acquisition.

In one embodiment, the monitor device is a single or limited use device that is fabricated from a lightweight, durable plastic. In the exemplary embodiment, the flow cell is injection molded in an ISO Class 7 cleanroom from a USP Class VI polypropylene material that is specifically formulated for biomedical and bioprocess applications. In other embodiments, the flow cell may be fabricated from any other material that enables the flow cell to function as described herein. The single use flow cell described herein provides process users with a reliable method to monitor process fluid variables, such as, but not limited to, the absorbance and/or concentration of their bioprocess.

In the exemplary embodiment, the process monitor is fabricated symmetrically, but is not limited to only being symmetric. Moreover, in the exemplary embodiment, the flow cell is assembled without the use of any mechanical fasteners and/or any epoxy, glue, adhesive, resins, or any other adhesive. Rather, the process monitor device described herein is formed with a biasing mechanism that enables the flow cell to be assembled using only a snap-fit configuration (or an interference fit) that ensures the components of the flow cell are securely coupled together.

In the exemplary embodiment, when the process monitor is fully assembled, a monitoring chamber is defined within the flow cell at an intersection of a fluid flow path and an optical path. More specifically, in the exemplary embodiment, within the snap-fit configuration (or the interference fit configuration), adjacent components cooperate to apply a consistent pressure to securely “sandwich” an O-ring in position such that a substantially tight leak proof configuration is facilitated between the fluid flow path and the optical path. Moreover, the snap-fit or interference fit configuration also facilitates reducing “dead-flow” areas that may be created within the monitoring chamber. Furthermore, in the exemplary embodiment, the snap-fit or interference fit configuration facilitates preventing the flow cell components from being mis-aligned and/or being coupled together in any improper orientations.

At least one of the technical problems addressed by this system may include: (i) providing a cost-effective process monitor device that is designed for single-use; (ii) reducing dead-flow potential stagnation volumetric areas within the defined monitoring chamber of the flow cell; (iii) providing a single-use flow cell that is assembled without the use of any mechanical fasteners and/or any adhesive products; (iv) providing a flow cell that produces reliable and repeatable results within a monitoring chamber defined by controlled dimensions; and/or (v) providing a flow cell that is assembled in a murphy-proofed snap-fit or interference fit configuration.

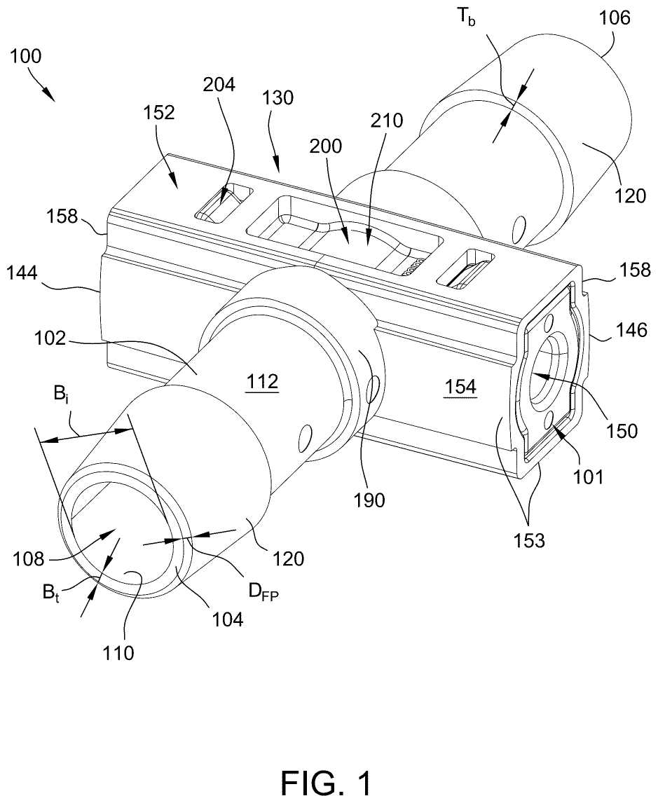

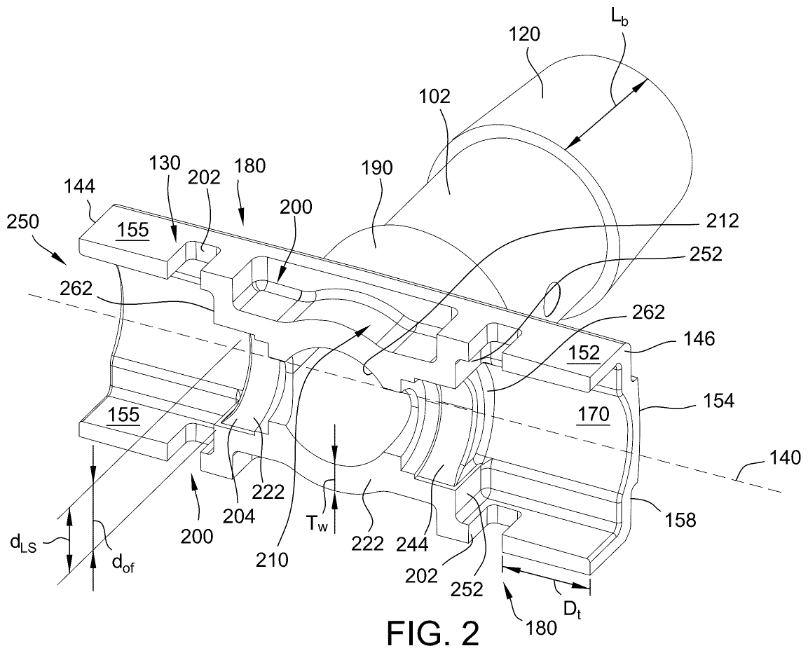

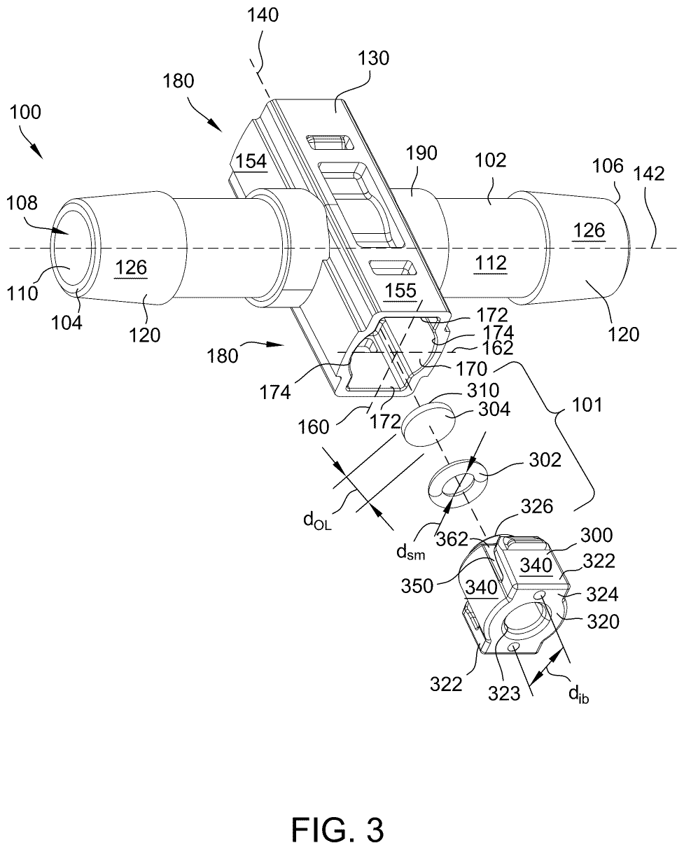

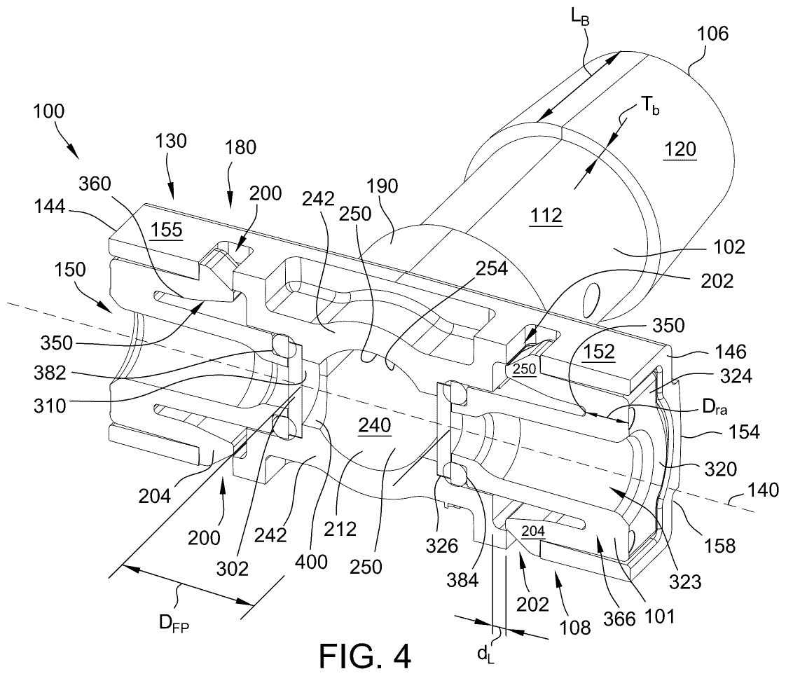

FIG. 1 illustrates a perspective view of an exemplary process monitor device 100 that may be used to monitor a process variable in real-time that facilitates maintaining a process environment with minimal microbial contamination. FIG. 2 is a partial cut-away perspective view of the process monitor device 100 taken along line 2-2. For clarity, within FIG. 2, a pair of optical interface assemblies 101 have been removed. FIG. 3 is a partially exploded perspective view of a portion of the process monitor device 100. FIG. 4 is a partial cut-away view of the process monitor device 100 shown in FIG. 3 and including the optical interface assemblies 101. In the exemplary embodiment, process monitor device 100 is a flow cell designed for single or limited time use, but is not limited to only being, a flow cell.

In the exemplary embodiment, when assembled, the flow cell 100 includes a central body 102 that extends substantially longitudinally from a first end 104 to a second end 106. Central body 102, in the exemplary embodiment, is substantially cylindrical is fabricated as a one-piece, annular member that is formed with a central bore 108 extending therethrough. The central bore 108 is defined by an inner sidewall surface 110 of the central body 102. The inner sidewall surface 110 defines an inner diameter Bᵢ of the central body 102, and an outer sidewall surface 112 defines an outer diameter Bₒ of the central body 102. Accordingly, in the exemplary embodiment, central body 102 has a substantially circular cross-sectional shape defined by its outer sidewall surface 112. Alternatively, central body 102 may be formed with a non-circular cross-sectional shape as defined by its outer sidewall surface 112. For example, in an alternative embodiment, central body 102 may be formed with a substantially square cross-sectional shape, an elliptical cross-sectional shape, and/or a rectangular cross-sectional shape as defined by the central body outer sidewall 112. Moreover, central body 102 may be formed with any cross-sectional shape as defined by the outer sidewall surface 112 that enables flow cell 100 to function as described herein.

Central body 102 has a thickness Bₜ that is defined between the inner and outer sidewall surfaces 110 and 112, respectively. In the exemplary embodiment, central body thickness Bₜ is substantially constant within central body 102. In alternative embodiments, central body thickness Bₜ may be varied within central body 102. In one embodiment, body thickness Bₜ is between about 0.030″ to about 0.085″. In another embodiment, body thickness Bₜ is between about 0.035″ to about 0.080″. Alternatively, body thickness Bₜ may be any other thickness that enables flow cell 100 to function as described herein.

In the exemplary embodiment, central body 102 is formed symmetrically and each end 104 and 106 is formed with a connector 120 that enables the flow cell 100 to easily couple with other process components, such as flexible tubing. In the exemplary embodiment, connectors 120 are identical and each is formed as a ½ inch hose barb. In alternative embodiments, central body 102 is not formed symmetrically, and/or at least one end 104 or 106 is formed with a different connector 120 than the other end 106 or 104. Connectors 120 are not limited to only being standard hose barbs and rather, can be any other connecting or fastening mechanism that enables flow cell 100 to couple to other process components, as described herein. For example, at least one of the central body ends 104 and/or 106 may be formed as, but is not limited to only being formed as, a hose bead, a push-to-connect fitting, a quick connect fitting, a flare, a twist and lock fitting, a threaded fitting, and/or any other connecting means, including a combination of any of the aforementioned alternative ends 104 and/or 106, that enables flow cell 100 to easily couple to other process components. In another alternative embodiment, at least one of the central body ends 104 and/or 106 is formed with a flange that extends radially outward from the body outer sidewall surface 112 that not only enables flow cell 100 to couple to other process components, but also functions as a stop that facilitates limiting how far tubing, for example, can be mounted to the flow cell 100.

In each embodiment, the central body ends 104 and 106 are formed integrally with the connectors 120. The connectors 120 not only enable the flow cell 100 to easily connect with other process components, but in addition, the connectors 120 also facilitate ensuring that other process components are coupled to the flow cell 100 in a predictable and repeatable position relative to the flow cell 100. In the exemplary embodiment, each connector 120 circumscribes central body 102 and such an outer surface 126 of each connector 120 is radially outward from central body outer surface 112. In the exemplary embodiment, as is known in the art, hose barbs 120 are tapered such that a thickness T_{b} of each varies along its longitudinal length L_{b}. In other embodiments, such as when a connector 120 is formed as a flange, the thickness T_{b} of each connector 120 may be substantially uniform.

In the exemplary embodiment, central body 102 is also formed integrally with an optical housing 130 that enables light energy to be transmitted through fluid flowing through the flow cell 100. More specifically, in the exemplary embodiment, central body 102 includes only a single optical housing 130 that is substantially centered within central body 102. In alternative embodiments, central body 102 may be formed integrally with more than one optical housing 130 to enable either concurrent or selective monitoring of more than one process fluid variable via flow cell 100. Moreover, in other embodiments, the optical housing 130 is not substantially centered within central body 102.

In the exemplary embodiment, when assembled, optical housing 130 is formed symmetrically and includes an axis of symmetry 140 that is oriented generally laterally and that is substantially perpendicularly to a longitudinal axis of symmetry 142 for the central body 102. Alternatively, optical housing 130 may be oriented at any other orientation that enables flow cell 100 to function as described herein. For example, in one alternative embodiment, optical housing 130 is obliquely oriented relative to axis of symmetry 142. In the exemplary embodiment, housing 130 extends substantially laterally from a first outer end 144 to a second outer end 146. The optical housing 130, in the exemplary embodiment, is formed as a one-piece annular member that is formed with a central bore 150 extending therethrough. The optical housing includes an outer surface 152 that is defined by four sidewalls 153 that are each oriented substantially perpendicularly to each other, such that opposing pairs of outer sidewalls 154 and 154, or 155 and 155 are substantially parallel to each other. In the exemplary embodiment, corners 158 that are offset generally inwardly extend between adjacent sidewalls 153. More specifically, the offset voids of the corners 158 are generally rectangular-shaped. Accordingly, with the exception of the offset corners 158, housing 130 has a generally rectangular cross-sectional profile defined by the outer sidewalls 153 that includes a major axis 160 and a minor axis 162. Alternatively, housing 130 may have any non-rectangular cross-sectional profile that enables the flow cell 100 to function as described herein.

The central bore 150 is defined by an inner sidewall 170 that is formed generally continuously about the central bore 150. In the exemplary embodiment, the inner sidewall 170 includes two-pairs of opposing portions 172 and 174 that extend from rounded corners 176. A first of the opposing pairs 172 are substantially planar, and the second of the opposing pairs 174 extend arcuately between the corners 158 in a mirrored relationship. Accordingly, in the exemplary embodiment, the central bore 150 is formed with a symmetrical cross-sectional shape that is generally rectangular. Alternatively, the central bore 150 may have any other cross-sectional shape that enables the flow cell 100 to function as described herein.

Each lateral arm 180 of the optical housing 130, in the exemplary embodiment, extends substantially perpendicularly outward from the central body 102. In the exemplary embodiment, each of the outer sidewalls 154 that are radially outward from the pair of opposing portions 174, i.e., the portions of the inner sidewall 170 that are arcuate, extend continuously, i.e., do not include any openings formed therein, from a support collar 190 to each respective optical housing outer end 144 and 146. As such, sidewalls 154 are substantially parallel to each other and are in a mirrored relationship. More specifically, in the exemplary embodiment, a pair of support collars 190 extend circumferentially around central body outer surface 112 and each is against, and is formed integrally with, each optical housing sidewall 154. Support collars 190 each facilitate enhancing the structural integrity of the union, i.e., the process fluid flow path and the optical path, defined within the central body 102 and the optical housing 130, respectively. In addition, support collars 190 provide a stop surface that limits an insertion depth of flow cell 100 within tubing (not shown) extending past connectors 120. In the exemplary embodiment, because the flow cell 100 is murphy-proofed, sidewalls 154 are identical. Alternatively, the sidewalls 154 may be different from each other.

Moreover, in the exemplary embodiment, each of the optical housing outer sidewalls 155 that are radially outward from the pair of opposing portions 172, i.e., the portions of the inner sidewall 170 that are substantially planar, extend in a mirrored relationship, from optical housing first outer end 144 to housing second outer end 146. More specifically, in the exemplary embodiment, the pair of outer sidewalls 155 are identical and each is formed with three openings 200 that extend at least partially therethrough from the optical housing outer surface 152 inwardly towards the optical housing central bore 150.

In the exemplary embodiment, two of the openings 200 defined in outer surface 152 are locking tab openings 202 that are sized and shaped to retain a locking tab 204 therein, as described in more detail below. More specifically, in the exemplary embodiment, locking tab openings 202 are identical and is generally rectangular-shaped. Moreover, openings 202 are each substantially centered between outer sidewalls 154 and each is spaced a defined distance Dₜ from each respective optical housing outer end 144 and 146. Accordingly, in the exemplary embodiment each opening 202 extends through each sidewall 155 from outer surface 152 into the optical housing central bore 150.

In the exemplary embodiment, a third of the openings 200 defined in outer surface 152 is an indicia recess 210 that enables, for example, a size of the flow cell 100, i.e., a size of the defined optical path within the flow cell 100, and/or a manufacturer of the flow cell 100, to be identified to a user with indicia. In addition, the exclusion of material within recess 210 facilitates reducing manufacturing costs of the flow cell 100. Furthermore, the absence of material within recess 210 facilitates enhancing the manufacturing process of the flow cell 100. For example, the absences of material within recess 210 facilitates reducing the overall thickness of the flow cell 210, facilitates reducing a likelihood of warping of the flow cell 100, and enhances the structural integrity, moldability, and rigidity of flow cell 100 at the union, i.e., the intersection, of the fluid flow and optical paths.

Recess 210 is defined radially outwardly from an adaptor coupling portion 220 of the optical housing 130. Thus, in the exemplary embodiment, a radially inner surface 212 of the recess 210 defines the radially outer surface of the monitoring chamber 240 within an adaptor coupling portion 220 of the optical housing 130. In the exemplary embodiment, the adaptor coupling portion 220 is substantially centered within the optical housing 130 and is defined by walls 222 that are each formed with a thickness T_{w} that is thicker than other walls, such as sidewalls 153 for example, within the flow cell 100. The additional thickness T_{w} enhances the structural integrity and rigidity of the monitoring chamber 240 defined at the union, i.e., the intersection, of the fluid flow and optical paths within the central body 102 and the optical housing 130, respectively. More specifically, when the process monitor 100 is fully assembled, the monitoring chamber 240 is substantially centered within the flow cell 100 at the intersection of the fluid flow path and the optical path.

In the exemplary embodiment, the adaptor coupling portion walls 222 each include a pair of contoured walls 242 that are in a mirrored relationship and that each extend diametrically inward from optical housing sidewalls 155, and two pairs of arcuate support members 244 that each extend between the pair of opposed contoured walls 242. More specifically, each contoured wall 242 includes a center portion 250 that extends arcuately between a pair of stops 252 that are between the monitoring chamber 240 and each respective outer end 144 and 145 of the optical housing 130. In the exemplary embodiment, the center portion 250 is formed with a radius of curvature that substantially matches the radius of curvature defined within fluid flow path of the central body 102 by inner surface 110. As such, when the flow cell 100 is fully assembled, an inner surface 254 of the center portion 250 is substantially flush with the inner surface 110 defining the central bore 108 through the central body 102. Accordingly, in the exemplary embodiment, the monitoring chamber 240 does not adversely influence, nor disrupt, the flow of a process fluid flowing through the fluid flow path defined through the central body 102.

The adaptor coupling portion support members 244 each extend arcuately between the opposed contoured walls 242. More specifically, in the exemplary embodiment, the support members 244 are between the locking tab openings 202 and the monitoring chamber 240. Moreover, in the exemplary embodiment, a radially outer surface 260 of each of the support members 244 is substantially planar and forms, in combination with a portion of each of the contoured walls 242, at least a portion of a generally toroidal and substantially planar lens or window seat 262. Each lens seat 262 is a distance d_{L} laterally inward, i.e., towards the monitoring chamber 240, from the locking tab openings 202.

In the exemplary embodiment, the pair of optical interface assemblies 101 each include a retainer member 300, a sealing member 302, and an optical lens or window 304. Optical interface assemblies 101 enable an analyzer, such as, but not limited to, an optical absorption analyzer, a chromatography machine, a mass spectrometer, and/or any other analyzer that may be used to monitor optical properties and characteristics, such as the turbidity of the process fluid flowing through the flow cell monitoring chamber, for example, to be coupled to the flow cell 100. In the exemplary embodiment, the optical lens 304 is a round lens that has a diameter d_{OL} that is slightly smaller than a diameter d_{OF} of the optical flow path defined at the coupling portion pair of stops 252. The lens seat 262 facilitates positioning the lens 304 in a repeatable and reliable manner each time a lens 304 is inserted within an optical housing 130. Moreover, a diameter d_{LS} of the lens seat 262 is generally the same size as the diameter d_{OF} of the optical flow path defined at the coupling portion pair of stops 252.

In addition, in the exemplary embodiment, the optical lens 304 includes at least one substantially planar side 310, i.e., the lateral inner side, that enables the optical lens 304 to seat substantially flush against the optical housing lens seat 262 when fully installed within the optical housing 130. In the exemplary embodiment, an opposite side 312, i.e., a lateral outer side, of the lens 304 is also substantially planar. Alternatively, the outer side 312 of the lens 304 may have any non-planar shape, such as convex, and/or the lens 304 may have any polarization, color, tint, and/or any other lens characteristic that enables the flow cell 100 to function as described herein.

The optical lens 304 is variably selected to enable a specific wavelength of light to be projected therethrough with a desired focal point, and to enable a desired process variable of the process fluid flowing through the monitoring chamber 240 to be monitored. More specifically, when each optical lens 304 is fully installed within the optical housing 130, a pre-defined distance D_{FP}, known as an optical flow path length, is defined between the lenses 304. The defined distance D_{FP} ensures that a desired specific optical flow path length, is defined within the monitoring chamber 240 that facilitates enabling desired process variables of process fluid flowing therethrough, to be monitored. Controlling and maintaining the defined distance D_{FP} between the pair of lenses 304 is essential to the operation of the flow cell 100 and facilitates optimizing the accuracy of data acquisition using the flow cell 100.

In one embodiment, the optical flow path length, distance D_{FP}, is defined to be about 2 mm. In another embodiment, the optical flow path length, distance D_{FP}, is about 5 mm. In yet another embodiment, the optical flow path length, distance D_{FP}, is about 10 mm. In alternative embodiments, the optical flow path length, distance D_{FP}, may be variably selected to be any other length that enables flow cell 100 to function as described herein.

In the exemplary embodiment, a sealing member 302 facilitates retaining the lens 304 in position against the lens seat 262 when the flow cell 100 is fully assembled. More specifically, in the exemplary embodiment, the sealing member 302 is an annular O-ring that is compressed, as described in more detail below, against the outer circumference of the outer side 312 of the lens 304. In the exemplary embodiment, the sealing member 302 is fabricated from a compressible material that is different than the material used in fabricating the remainder of the flow cell 100. For example, in one embodiment, the sealing member is fabricated from a rubber material, a polyurethane material, and/or any other compressible sealing material that enables the flow cell 100 to function as described herein. Accordingly, unlike a location of known O-rings that are commonly used in process monitoring equipment, the sealing member 302 described herein may remain “dry” or isolated from the process fluid flowing through the flow cell 100, depending on the pressure of the fluid flowing through the flow cell 100. As such, in such operating conditions, the risk of the sealing member 302 degrading prematurely, reacting with the process fluid, and/or contaminating the process fluid is facilitated to be eliminated. Moreover, in the present invention, the combination of the location of the sealing member 302 relative to the lens 304, and the substantially consistent force induced to the sealing member 302, facilitates substantially eliminating, a risk of process fluid seepage or leakage past the lens 304 and into the optical flow path.

In the exemplary embodiment, the optical interface assemblies 101 are identical and each includes a retainer member 300 that couples within the flow cell 100, as described in more detail below, and that enables monitoring equipment, such as, but not limited to, an optical absorption analyzer, to be coupled to the flow cell 100 in a reliable and repeatable manner. More specifically, in the exemplary embodiment, the optical interface assemblies 101 are manufactured from the same resilient material(s) as the remaining portions of the flow cell 100.

In the exemplary embodiment, each optical interface assembly 101 includes a central body portion 320 and a pair of integrally formed retaining arms 322. The central body portion 320 includes an interface bore 323 extending therethrough from a radially outer surface 324 of the optical interface assembly 101 to a radially inner surface 326 of the assembly 101. The interface bore 323 is substantially centered within the body portion 320 and is thus substantially concentrically aligned with the central bore 150 extending laterally through the optical housing 130. In the exemplary embodiment, a diameter d_{ib} of the interface bore is generally the same size as an inner diameter dₛₘ of the sealing member 302.

The retainer 300 has a cross-sectional shape, defined in combination by the central body portion 320 and the retaining arms 322, that is substantially similar to a cross-sectional shape defined by the central bore 150 of the optical housing 130. Accordingly, when the retainer 300 is fully inserted within, i.e., slidably coupled within, the central bore 150, the outer surface 340 of the retainer 300 is positioned tightly against the inner sidewall 170 of the central bore 150 in either an interference fit or a snap fit. Alternatively, the retainer 300 may be securely coupled within the central bore 150 using any other coupling configuration that enables the flow cell 100 to function as described herein, including, but not limited to, a quarter turn coupling configuration, a threaded coupling configuration, a crimped configuration, a pinned-in-place configuration, a quick-disconnect configuration, and/or via at least one mechanical fastener.

In the exemplary embodiment, the retaining arms 322 are each formed integrally with the central body portion 320. More specifically, a pair of channels 350 each extend partially laterally along the opposed substantially planar sides 354 of the central body portion 320. As such, each channel 350 creates a distance of separation between a radially inner side 360 of each retaining arm 322 and a radially outer surface 362 of central body portion 320. Accordingly, in the exemplary embodiment, each retaining arm 322 extends outwardly from central body portion 320. More specifically, in the exemplary embodiment, a shoulder area 366 is defined between each arm 322 and central body portion 320. The shoulder area 366, in the exemplary embodiment, extends laterally inward a distance Dᵣₐ from the outer surface 324 of the optical interface assembly 101. More specifically, in the exemplary embodiment, each arm 322 extends from the shoulder area 366 to a locking tab 204.

Locking tabs 204, in the exemplary embodiment, are identical and each has a generally triangular cross-sectional shape. Moreover, each locking tab 204 is sized to be received in a tight tolerance within a respective locking tab opening 202 defined in outer surface 152.

The radial inner surface 326 of the central body is formed with an annular seal member seat 380 that is sized to receive at least a portion of the sealing member 302 therein. ore specifically, the seal member seat 380 includes a laterally extending stop surface 382 and a radially extending surface 384. Accordingly, as the retainer 300 is being inserted within the optical housing 130, the sealing member 302 essentially is seated within the annular seal member seat 380 such that surface 382 is radially inward from the sealing member 302, and such that surface 384 is laterally outside of the sealing member 302. Moreover, when the retainer 300 is fully inserted within the optical housing 130, the annular seal member seat 380 induces a substantially consistent and annular compressive force against the sealing member 302. More specifically, the compressive force is induced to the “rear side”of the O-ring 302, in the exemplary embodiment.

The compressive force is induced consistently to the O-ring 302 and thus, against the outer circumference of the outer side 312 of the lens 304. As such, once the optical housing 130 is fully assembled, the sealing member 302 facilitates retaining the lens 304 in sealing contact against the lens seat 262. More specifically, the retainer 300 induces a compressive force against the O-ring 302 and against the outer circumference of the lens 304, such that process fluid leakage between the lens seat 262 and the lens 304 is facilitated to be prevented.

In addition, in the exemplary embodiment, the combination of the interference or snap-fit created between the optical housing 130 and the central body 102 facilitates reducing dead-flow areas 400 that may be created within or around the monitoring chamber 240. More specifically, the combination of the geometry of the adaptor cooping portion 220 and the relative location of the lenses 304 facilitates reducing the volume of any dead-flow areas 400 that may be created. As used herein, dead-flow areas 400 are volumetric areas that may be created within the monitoring chamber 240 wherein the flow of process fluid may be slowed or potentially stagnated.

In the exemplary embodiment, the flow cell 100 is injection molded in an ISO Class 7 cleanroom from a USP Class VI polypropylene material that is specifically formulated for biomedical and bioprocess applications. The single use flow cell described herein provides process users with a reliable method to monitor process fluid variables, such as, but not limited to, the absorbance and/or concentration of their bioprocess.

During assembly, each lens 304 is inserted within the optical housing 130 and is positioned such that the planar side 310 of the lens 304 is positioned against the stops 252 and within the lens seat 262. The stops 252 ensure that the lenses 304 are positioned precisely, such that the specific optical flow path length D_{FP} is defined within the monitoring chamber 240 and between the pair of lenses 304. In the exemplary embodiment, each O-ring 302 is then inserted into the annular seal member seat 380, and the retainer 300 is then inserted within the optical housing 130. More specifically, the retainer 300 is slidably inserted within the central bore 150 of the optical housing 130. As the retainer 300 is slid inwardly towards the monitoring chamber 240, the wedge-shape of the locking tabs 204 causes the resilient retaining arms 322 to flex radially inward to enable their insertion within the central bore 150. In other words, the channels 350 allow the retaining arms 322 to flex inwardly towards the central body portion 320. The retainer 300 is slid inwardly towards the monitoring chamber 240 until the radially inner surface 326 of the assembly 101 contacts the lens 304 and the locking tabs 204 have been biased into and received in a tight tolerance within the locking tab openings 202.

When the retainer 300 is fully inserted within the optical housing 130, as described above, a compressive force causes the O-ring to compress between the retainer 300 and the lens 304 such that the lens is held in an accurate and desirable position, and such that process fluid flow leakages between the lens seat 352 and the lens 304 is facilitated to be prevented. Moreover, the interference fit or thesnap-fit that completes the assembly of the flow cell 100 is performed without the use of any mechanical fasteners and/or any epoxy, glue, adhesive, resins, or any other adhesive. In addition, combination of the interference fit or the snap-fit configuration, coupled with the tight tolerances, would make the removal of the retainer member 300 difficult without damaging the flow cell 100. Accordingly, in the exemplary embodiment, the flow cell 100 is designed and intended to be disposed, rather than cleaned, following a pre-defined single or limited use.

The assembled flow cell 100 is delivered to the process-user for coupling in-line to a process fluid to be analyzed. Additional monitoring components may be easily coupled to the flow cell 100 to enable light energy to be transmitted through the optical housing 130 to enable process fluid flowing through the flow cell central body 102 to be continuously monitored within the monitoring chamber 240. The flow cell 100 is not designed to retain process fluid therein for analysis, but rather the fluid is simply interrogated and analyzed as it flows through the flow cell 100.

In the exemplary embodiment, the flow cell 100 is injection molded from a resilient and light-weight plastic material, but is not limited to only being injection molded and/or fabricated from a light-weight plastic material. Rather, any other fabrication or manufacturing process may be used that enables the flow cell 100 to be fabricated as described herein and that is cost-effective for a single or limited usage. For example, in one embodiment, the flow cell 100 is fabricated via an additive manufacturing process, such as, but not limited to, a 3D printing process, a binder jetting process, a material jetting process, a material extrusion process, a sheet lamination process, a powder bed fusion process, and/or a vat photopolymerization process. In one embodiment, the optical housing retainer member 300 is fabricated with a different colored material than the optical housing 130 to facilitate an easier visual confirmation that the locking tabs 204 have fully snapped into the locking tab openings 202.

Because the flow cell 100 described herein is fabricated symmetrically, the installation of the flow cell 100 within the process environment is not directionally limited and either end 104 or 106 of the flow cell 100 could be coupled upstream from the other end within the process environment with minimal microbial contamination. Accordingly, the universal fittings included with the single use flow cell 100 described herein, increase the flexibility of its use. Following its use, i.e., after a select number of batches have been manufactured, for example, the flow cell 100 is disposable and is not designed to be cleaned. In addition, if light energy of a different wavelength is necessary, the flow cell 100 should be disposed and replaced with a flow cell having a different optical flow path length D_{FP}.

The exemplary systems and methods described and illustrated herein provide a single or limited use flow cell that is assembled without the use of any mechanical fasteners or any adhesive products. Moreover, the geometry of the flow cell facilitates ensuring that a monitoring chamber having a precise optical flow path length is produced in a reliable, repeatable, and cost-effective manner. In addition, the flow cell described herein is assembled in a murphy-proofed, snap-fit (or interference fit) configuration that facilitates reducing human assembly errors, facilitates reducing costs to the process user, and that facilitates enhancing the flexibility of installation for the process user.

In addition, because the flow cell is a cost-effective single use component, cleaning and re-validation costs and expenses are eliminated. In addition, the symmetry of the flow cell facilitates increasing the ease of installation and coupling to additional process components. As such, the present systems and methods are further advantageous over conventional techniques because the embodiments described herein are not confined to a single type of flow cell or coupling to a single type of process, but may instead allow for versatile integration within multiple different types of processes.

Exemplary embodiments of systems and methods for single use flow cells are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A single use flow cell for use in-line monitoring, the cell comprising:
a one-piece central body integrally formed with an optical housing, wherein the central body comprises an inlet, an outlet, and a central bore extending therethrough from the inlet to the outlet, the optical housing comprises a first end, a second end, and a housing bore extending from the first end to the second end; and
an optical retainer slidably coupled in one of an interference fit and a snap-fit within the central body such that at least a portion of the optical retainer is securely coupled within at least one opening formed within the optical housing.

2. The single use flow cell in accordance with claim 1 wherein the union of the central body and the optical housing defines a monitoring chamber within the flow cell, the monitoring chamber having a pre-defined optical focal path length.

3. The single use flow cell in accordance with claim 2 wherein a portion of the monitoring chamber is defined by a pair of opposed windows, wherein a distance between the pair of windows defines the optical focal path length of the monitoring chamber.

4. The single use flow cell in accordance with claim 3 wherein each of the windows includes at least one substantially planar surface, and wherein at least a portion of the optical housing forms a seat oriented to position each of the windows within the flow cell such that the at least one substantially planar surface of each window is between the central bore and the optical retainer.

5. The single use flow cell in accordance with claim 3 wherein at least a portion of the optical housing forms an annular stop, at least one of the windows is positioned in sealing contact against the annular stop.

6. The single use flow cell in accordance with claim 3 wherein the position of the pair of opposed windows relative to the central bore facilitates reducing an amount of dead flow areas by volume defined within the monitoring chamber.

7. The single use flow cell in accordance with claim 3 wherein each of the windows includes at least one substantially planar surface, and wherein a pair of O-rings are each compressed against a respective one of the windows such that the O-ring is between the window and the optical retainer.

8. The single use flow cell in accordance with claim 7 wherein each of the pair of O-rings remains dry during monitoring.

9. The single use flow cell in accordance with claim 1 wherein the flow cell is symmetric.

10. A single use flow cell for use in monitoring a process fluid flowing therethrough, the single use flow cell comprising:
a hollow central body;
a hollow optical housing formed integrally with the central body, the optical housing including at least a pair of openings formed diametrically apart from each other; and
an optical retainer slidably coupled within the optical housing such that the optical retainer is retained in one of an interference fit and a snap-fit configuration with the optical housing.

11. The single use flow cell in accordance with claim 9 wherein the optical retainer is securely retained within the optical housing without the use of any adhesive product.

12. The single use flow cell in accordance with claim 10 wherein the optical retainer includes at least two biasing mechanisms that each include a locking tab, each of the locking tabs is sized to fit in a tight tolerance within a respective one of the pair of openings formed within the optical housing.

13. The single use flow cell in accordance with claim 10 further including a pair of windows spaced laterally apart, each of the windows is spaced laterally within the flow cell such that each window is between the central body and the pair of openings formed within the optical housing.

14. The single use flow cell in accordance with claim 13 further including a pair of seal rings positioned in sealing contact against a circumference of each of the windows, wherein the optical retainer induces a consistent compressive force against the seal rings when the optical retainer is coupled within the optical housing.

15. The single use flow cell in accordance with claim 10 wherein a cross-sectional profile defined by an outer surface of the optical retainer is substantially the same shape and size as a cross-sectional profile defined by an inner surface of a bore extending at least partially through the optical housing.

16. The single use flow cell in accordance with claim 10 wherein a portion of the optical housing forms a stop that limits a distance the optical retainer may be slidably coupled within the optical housing.

17. The single use flow cell in accordance with claim 10 wherein a diameter of a bore extending through the hollow central body is substantially constant therethrough.

18. An in-line process monitor comprising:
a one-piece central body integrally formed with an optical housing, the central body defining a fluid flow path extending therethrough, the optical housing including an interface bore extending therethrough; and
an optical retainer slidably coupled within the interface bore in one of an interference fit and a snap-fit, at least a portion of the optical retainer is received within a portion of the optical housing, wherein an intersection of the central body and the optical housing defines a monitoring chamber that is bordered at least partially by at least two windows that are oriented to enable light energy to be transmitted through the optical housing and through fluid flowing through the fluid flow path.

19. The process monitor of claim 18 wherein the optical retainer is securely retained within the optical housing without the use of any adhesive product, and wherein the optical retainer includes at least two locking tabs that are each biased radially outwardly into a respective opening formed in the optical housing.

20. The process monitor of claim 18 wherein the optical retainer is sized and oriented to induce a compressive force against each of a pair of O-rings positioned between the optical retainer and each of the windows.
